(19) United States
(12) Patent Application Publication
(10) Pub. No.: US 2008/0011880 A1
(43) Pub. Date: Jan. 17, 2008

(54) Sanitary Showerhead

(76) Inventors: Klaus Butzke, Schiltach (DE); Franz Schorn, Schiltach (DE)

Correspondence Address: DUANE MORRIS, LLP;IP DEPARTMENT, 30 SOUTH 17TH STREET, PHILADELPHIA, PA, 19103-4196, US

(21) Appl. No.: 11/720,236

(22) PCT Filed: Nov. 30, 2005
(86) PCT No.: PCT/EP05/12757

§ 371 Date: Aug. 31, 2007

(30) Foreign Application Priority Data
Dec. 1, 2004 (DE) 10 2004 059 328.0

(51) Int. Cl. B05B 1/18

(52) U.S. Cl. 239/428.5

(57) ABSTRACT

The invention relates to a shower head that can be used, for example, as a hand-held shower attachment. The shower head contains an aerating device that is capable of supplying all jet outlet elements (16) of the jet disc (18) with aerated water. The air required for this is aspirated at a number of locations and mixed with the water with the aid of a number of nozzles (14) inside the shower head. The aerated water already present inside at least one chamber (17) leaves this chamber and then passes through the jet outlet elements (16) into the open.

The invention relates to a showerhead for a sanitary fitting. It is known that different types of jets can be produce with sanitary showerheads. Particularly favoured are aerated jets, in which air bubbles can be mixed with the water jet ensuing from a jet outlet element.

Typically, in conventional showerheads, the possibility exists to generate such aerated jets. Special jet outlet elements are provided for aerated jets, which are normally located in one part of the jet disc.

For some time now, showerheads are known, which feature a relatively large diameter and are made very flat.

The object of the invention is to provide a showerhead with the help of which the user can be provided with a large-area showerhead, thus a pleasant showering experience.

To achieve this object, the invention proposes a showerhead with the features mentioned in Claim 1. Developments of the invention are object of dependent claims.

The jet outlet elements from which an aerated jet is produced are now distributed over practically the entire jet disc. In large-area jet discs a jet field is generated in the entire cross-section, in that aerated jets are present everywhere. This generates a very pleasant feeling on the user's skin. To generate this large jet field it is not necessary for all jet outlet elements to produce these aerated jets.

In further development, it can also be provided that all jet outlet elements of the jet disc are formed for issuing aerated jets, if necessary, with exception of an area disposed in the middle of the jet disc, for example, in which other jets can be issued.

In further development of the invention, it can be facilitated that the aspirating device is formed for concurrently aerating several jet outlet elements. It is not required as such that each jet outlet element is provided with an independent air suction device.

To be able to ensure particularly in large-area jet showerheads that aeration can occur from all the jet outlet elements in the same manner, the aspirating device can be made according to the invention so that it sucks air at several points of the jet disc and/or of the showerhead housing, which are preferably disposed in a distributed manner over the jet disc or over the showerhead housing.

It has particularly proved advantageous to dispose the air suction openings aligned along the circumference of the jet disc. By doing so, the jet disc itself is neither impaired nor influenced in its optical appearance. In particular, the jet outlet openings are made in a manner that slits are formed around the circumference of the jet disc or a divided slit that serves air suction is formed if necessary. This slit is practically no longer visible and therefore does not interfere with the appearance of the showerhead.

With each especially large jet disc, it is also possible to arrange individual air suction openings in the jet disc itself, which can then be used as design elements.

The invention proposes to design the aeration of the water flowing out of the jet outlet elements such that the actual aeration occurs within the showerhead and that the water aerated within the showerhead enters the jet outlet elements from there, whereby several jet outlet elements are preferably supplied from one or from several chambers.

Further features, details, and preferences of the invention are derived from the claims and abstract whose wording is based on reference to the content of the description, and of the following description of a preferred embodiment of the invention and of the drawing. The figures show:

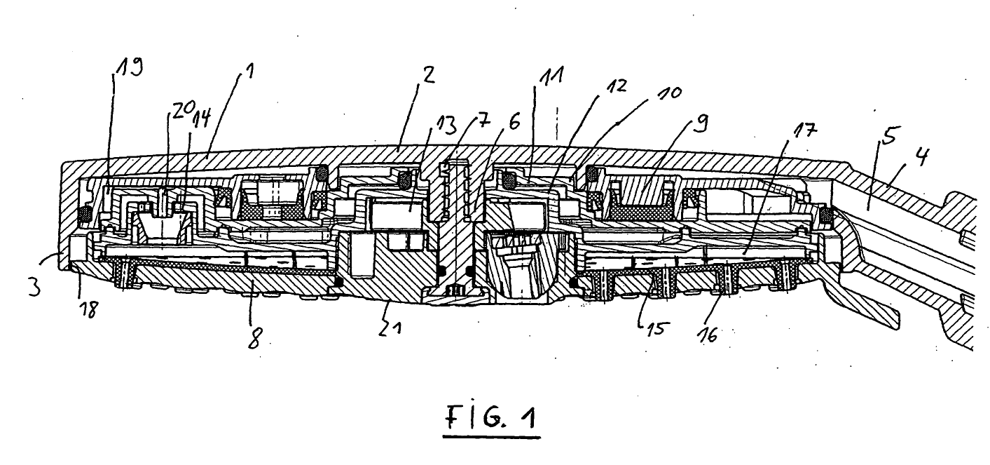

FIG. 1 a section through a flat showerhead;

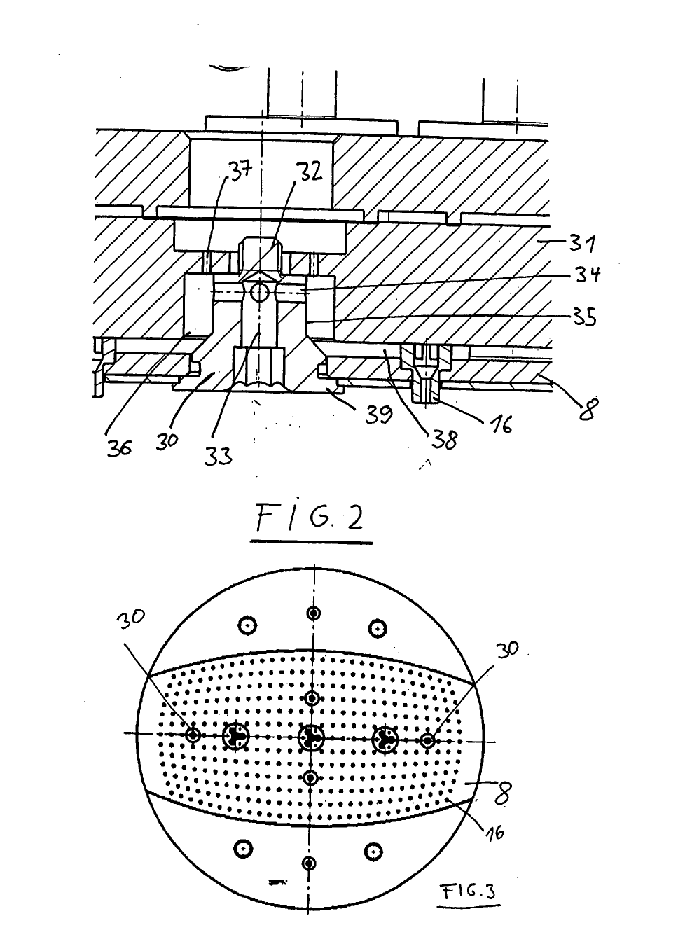

FIG. 2 a partial section through a showerhead with an aeration element, in magnified scale;

FIG. 3 a front view of a showerhead with a large-area jet disc in reduced scale.

The showerhead depicted sectionally in FIG. 1 contains a showerhead housing 1 with a housing floor 2 and a cylindrical jacket 3. On the right side in FIG. 1 a grip 4 is attached to the showerhead housing 1, through which the water can enter the interior of the showerhead housing 1 through a channel 5.

The housing floor 2 features a cylindrical attachment point 6 on its interior side, with an interior opening 7, which serves the purpose of securing the jet disc 8 on the showerhead housing 1.

A pivoted floor part 9 is on the housing floor 2, which forms a part of the interior of the showerhead housing 1. A lid part 10 adjoins the floor part 9, which rests on the floor part 9 with its middle section 11 within an opening. A distributing disc 12 adjoins in the direction away from the housing floor 2, which creates space for a turbine 13 in its middle section.

Nozzles 14 are formed in the outside edge of the distributing disc in a depression, which are used for aerating the water.

The interior of the showerhead housing is then closed outwards through the already mentioned jet disc 8, which in its interior side contains a jet disc insert 15 with jet outlet elements 16.

An internal space or chamber 17 is formed between the distributing disc 12 and the jet disc insert 15, from which the jet outlet elements 16 allow outflow into the open.

The jet disc 8 in the depicted embodiment is arranged such that it comes to rest with its outside circumference 18 still within the cylinder jacket 3 of the showerhead housing 1. Between the interior side of the outer jacket 3 of the showerhead housing 1 and the edge of the jet disc 8 is an open narrow gap 18, which goes around the entire circumference of the jet disc 8. Through this gap, air can reach the interior of the showerhead housing 1. The air enters into a space 19 between the lid part 10 and the floor part 9. This space 19, for instance, is depicted on the left in FIG. 1. If now the water now flows from the space between the lid part 10 and the distributing disc 12 in to the nozzles 14 disposed in the outer area, then air is sucked from the space through the channels 20. The water inside the chamber 17 is aerated in that manner. The chamber 17 around the middle of the part holding the turbine is provided with air bubbles. This water provided with air bubbles, thus aerated, then flows into the open through the jet outlet elements 16. With exception of the middle area 21 of the jet disc, where other outlet possibilities are provided, only aerated water flows out of the large-area jet disc 8.

Now as regards FIG. 2. This shows a section of a showerhead in magnified scale, in which the air suction now takes place from the surface of the jet disc. An aeration element 30 is now used in the jet disc 8, which again contains a plurality of jet outlet elements 16. The aerating element 30 features an enlarged head 39, which lies with a flange on the top side of the jet disc 8. The aerating element 30 is screwed in an opening of an intermediate disc 31 with a threaded projection 32. It contains an axial passage 33 that leads to the interior from the outside of the aerating element 30. The passage 33 is made as a blind hole. It ends in front of the threaded projection 32. In the outer section, the passage 33 is provided with a key surface, so that it can be screwed in and out. From the passage 33, individual radial channels 34 lead to the jacket surface 35 of the aerating element 30. These radial channels 34 discharge into a space 36, in which the water enters individual narrow holes 37. The water that enters through the holes 37 into the space 36 sucks air from the channels 34 and carries it with it. This creates a mixture of air and water in the space between the intermediate element 31 and the jet disc 8, so that aerated water flows out of the jet outlet elements 16. Also, in this manner, it can be ensured that a plurality of jet outlet elements is supplied with aerated water, which is present in a space within the showerhead housing.

Several of such aerating elements 30 can be present in a very large jet disc. They can be used in addition to a gap surrounding the jet disc 8. An example of such a large-area jet disc 8 is depicted in FIG. 3. Several aerating elements 30 are provided here in the field occupied by jet outlet elements 16.

What is claimed is:

1. A showerhead for a sanitary fitting, comprising:
a showerhead housing,
a jet disc bordering the showerhead housing, the jet disc having a plurality of jet outlet elements leading to jet outlet openings,
a water guide inside the showerhead housing, and,
aspirating device for aerating water jets, the aspirating device being configured for aerating water entering the jet outlet elements, the jet outlet elements being distributed over the entire said jet disc.

2. The showerhead according to claim 1, wherein the aspirating device is configured for aerating the water entering all of the plurality of jet outlet elements.

3. The showerhead according to claim 1, wherein the aspirating device is configured for aerating several of the plurality of jet outlet openings concurrently.

4. The showerhead according to claim 1, wherein the aspirating device is configured for sucking air at several points.

5. The showerhead according to claim 1, wherein the aspirating device defines air suction openings, which air suction openings are disposed along a circumference of the jet disc.

6. The showerhead according to claim 1, wherein the aspirating device defines a circumferential air suction slit located in an area outside a circumference of the jet disc.

7. The showerhead according to claim 1, comprising individual air suction openings disposed in the jet disc.

8. The showerhead according to claim 1, wherein aeration occurs within the showerhead housing and only aerated water enters the jet outlet elements.

9. The showerhead according to claim 1, wherein at least one aerating element is disposed within the jet disc.

10. The showerhead according to claim 1, wherein at least an aerating element is used in the jet disc.

11. The showerhead according to claim 1, wherein at least an aerating element is disposed behind the jet disc.

12. The showerhead according to claim 4, wherein the several points are distributed over the jet disc.

13. The showerhead according to claim 6, wherein the jet disc is divided to form the air suction slit.
